(19) United States
(12) Patent Application Publication
(10) Pub. No.: US 2012/0314831 A1
(43) Pub. Date: Dec. 13, 2012

(54) Light Water Reactor TRISO Particle-Metal-Matrix Composite Fuel

(75) Inventors: Kurt A. Terrani, Knoxville, TN (US); James O. Kiggans, JR., Oak Ridge, TN (US)

(73) Assignee: UT-BATTELLE, LLC, Oak Ridge, TN (US)

(21) Appl. No.: 13/157,632

(22) Filed: Jun. 10, 2011

(51) Int. Cl. G21C 3/60; G21C 3/06

(52) U.S. Cl. 376/409; 427/6

(57) ABSTRACT

A metal matrix, microencapsulated nuclear fuel component includes an integral metal matrix having an outer buffer region and an inner fuel containing region; a multiplicity of nuclear fuel capsules embedded in the fuel containing region of the matrix for encapsulating a nuclear fuel particle and products resulting from nuclear and chemical reactions; and a nuclear fuel particle encapsulated in each of the nuclear capsules.

### STATEMENT REGARDING FEDERALLY SPONSORED RESEARCH

The United States Government has rights in this invention pursuant to contract no. DE-AC05-00OR22725 between the United States Department of Energy and UT-Battelle, LLC.

### BACKGROUND OF THE INVENTION

Well known tristructural-isotropic (TRISO) nuclear fuel comprises a fissile/fertile-material containing kernel (UO₂, UO₂+UC₂, or UN while addition of Th, Pu and other minor actinides and getting agents as well as other chemical forms is possible) that is coated with a porous carbon buffer layer, an inner pyrolytic carbon layer (IPyC), a silicon carbide (SiC) or zirconium carbide (ZrC) shell and finally an outer pyrolytic carbon layer (OPyC) and/or ZrC shell. Existing TRISO particle technology has been optimized so that all the damage due to fission fragments is effectively contained within the particle and the fission-gas release from the particles is almost nonexistent. The foregoing features are the main enablers of these fuels to achieve high burnups far beyond what is possible with conventional oxide fuels. This factor coupled with the high thermal conductivity of the fuel particle and matrix (compared to pure oxide) and the capability of burning Pu and minor actinides in the kernel have been the main drivers behind further development in this area. Related nuclear fuel particles include the well-known quadristructural-isotropic (QUADRISO) particles and bistructural-isotropic (BISO) particles.

Recently, many advanced light water reactor (LWR) fuel concepts have emerged from a portfolio of US National Laboratories that aim to extend and enhance fuel performance and increase operational reliability under the DOE-NE Fuel Cycle R&D Program's Advanced Fuels Campaign. These advance concepts include a range of metal and ceramic fuel designs that offer certain benefits while suffering from other practical or fundamental limitations.

Assuming the fuel pellet performance is adequate, as is the case of some of these advance fuel concepts, the main operational limitations of the conventional LWR oxide fuel will still remain with these advance fuels. Currently the operational performance limits for the LWR oxide fuel is mainly set by the performance of the thin-walled cladding under both steady-state and transient conditions. Hydrogen pickup and surface oxide formation set the operational limits on power and place a cap on maximum fuel burnup. Furthermore, grid-to-rod fretting, crud formation, cladding stress corrosion cracking, and complications that rise from formation of hot spots and defects on the cladding cause costly fuel failures that can disrupt or halt reactor operation. The invention described hereinbelow provides a major step in resolving the foregoing issues.

### BRIEF SUMMARY OF THE INVENTION

In accordance with examples of the present invention, the foregoing and other objects are achieved by a metal matrix, microencapsulated nuclear fuel component that includes an integral metal matrix having an outer buffer region and an inner fuel containing region; a multiplicity of nuclear fuel capsules embedded in the fuel containing region of the matrix for encapsulating a nuclear fuel particle and products resulting from nuclear and chemical reactions; and a nuclear fuel particle encapsulated in each of the nuclear capsules.

### BRIEF DESCRIPTION OF THE DRAWINGS

FIG. 1 is a cross-sectional diagram of a LWR TRISO particle-metal-matrix composite fuel rod in accordance with examples of the present invention.

FIG. 2 is a cross-sectional diagram of a TRISO particle.

FIG. 3 is a perspective view diagram of a fractured fuel rod segment in accordance with examples of the present invention.

FIG. 4 is a photomicrograph of a cut and polished cross section of a composite material comprising zirconium metal powder and TRISO particles in accordance with examples of the present invention.

FIG. 5 is a photomicrograph of a cut and polished cross section of a composite fuel rod in accordance with examples of the present invention.

For a better understanding of the present invention, together with other and further objects, advantages and capabilities thereof, reference is made to the following disclosure and appended claims in connection with the above-described drawings.

### DETAILED DESCRIPTION OF THE INVENTION

In the original gas-cooled reactor concepts that incorporate TRISO particles, the SiC shell around the fuel kernel was the second barrier (and a very suitable one) to fission-product release; effectively the role played by Zircaloy in LWR oxide fuel rods. This implies that incorporation of TRISO particles in LWRs would relieve the zirconium alloy cladding to act as the second barrier to fission product release since all the fission fragments and gases are contained within the particle. All that would be needed to fully utilize the benefits of TRISO particles in LWRs is an approach that integrates TRISO particles in a matrix satisfying the following criteria: resistant to waterside corrosion, exhibit adequate irradiation resistant, non-detrimental to neutron economy, and ductile to accommodate stresses under steady-state and transient fuel operation.

The invention described herein involves a single and integral fuel rod in which the TRISO particles are dispersed in a zirconium alloy matrix. A key feature of the present invention is incorporation of advance TRISO particles in LWRs while the thin cladding tube and its associated limitations and failure scenarios are eliminated altogether.

In accordance with the present invention, nuclear fuel particles such as, for example, BISO, TRISO, and/or QUADRISO particles are mixed with zirconium or zirconium alloy powder and packed inside a zirconium or zirconium alloy tube. Subsequently the entire assembly is consolidated through processes such as pressing, hot isotactic pressing, and/or extrusion to form a novel integral nuclear fuel rod, which is described in further detail hereinbelow.

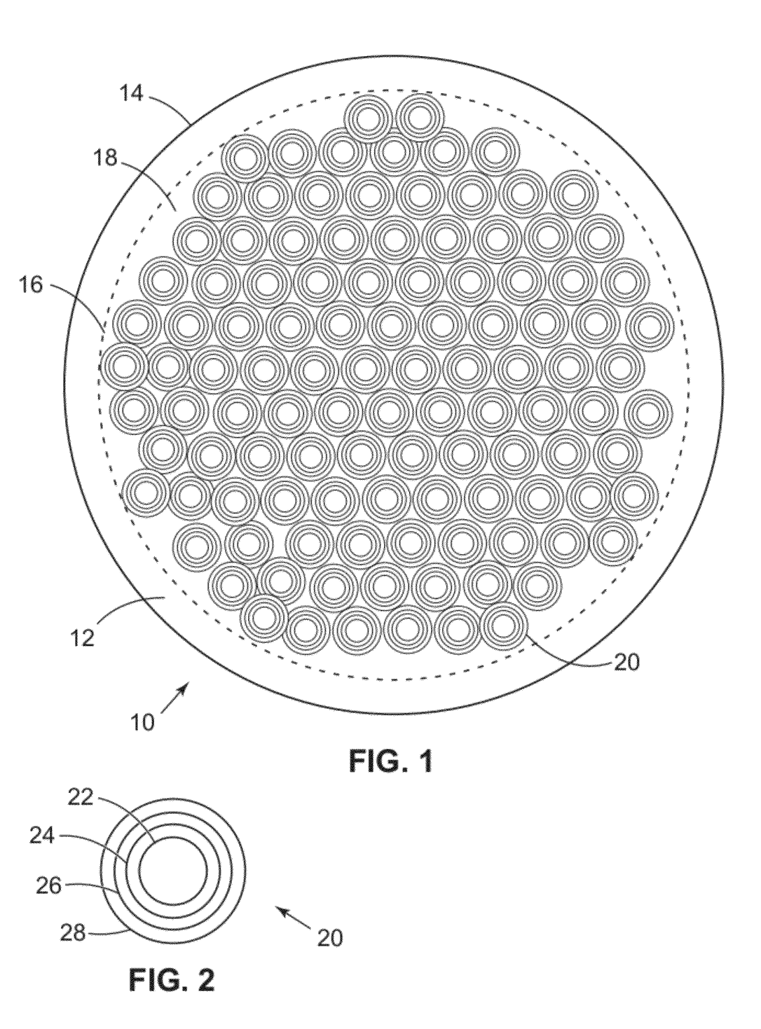

An example of the present invention is shown in FIG. 1. A nuclear fuel rod 10 generally comprises a metal matrix 14 and TRISO particles 20 dispersed therein. The metal matrix 14 comprises two integral but distinct regions: an outer buffer region 12, which is the original zirconium alloy tube, and an inner fuel containing region 18, within which the TRISO particles 20 dispersed. Generally, no TRISO particles 20 are dispersed in the outer buffer region 12, which is, for the purposes of description, distinguished from the inner fuel containing region 18 by an indistinct boundary 16.

FIG. 2 shows the general structure of a TRISO particle 20, including a kernel 22, a buffer layer 24, an inner pyrolytic carbon layer 26, and a SiC/ZrC shell 28. The TRISO particle can also have an additional outer pyrolytic carbon layer (OPyC) on the surface of the SiC/ZrC shell. Elimination of the OPyC will greatly increase uranium density.

The microstructure shown in FIGS. 1, 2 illustrates how the TRISO fuel particles (which generally have a mean diameter in the range of about 0.5-2 mm) are dispersed in the Zr metal matrix. The solid zirconium alloy matrix is integrated with the tubing used during the consolidation process to form a single solid fuel rod of any desired length (typical LWR fuel rod length is 4 meters).

An advantage of the present invention is the absence of a gap between the fuel pellet and the cladding; thereby a large thermal barrier has been eliminated. Moreover, high thermal conductivity of Zr metal further enhances the thermal conductivity of the composite fuel rod. A small temperature gradient across the fuel implies minimal energy is stored in the fuel and much better performance is expected under transient conditions such as Loss of Coolant Accidents (LOCA).

A further advantage of the present invention is the elimination of a thin cladding tube that, in current LWR fuel, was exposed to internal and external pressures at different points of fuel burnup. This eliminates cladding creep down, the bamboo effect, and ballooning and resolves issues due to grid-to-rod fretting and formation of hot spots. The state of stress across the fuel rod is very different from that in UO₂ pellets and is solely associated with the temperature gradient across the rod, which is minimal. The matrix is ductile and can accommodate stresses by plastic deformation and creep.

The fuel surface will still undergo oxidation and fretting wear; however it is not a thin tube that is readily susceptible to severe damage by cracking. The hydrogen picked up as a result of oxidation will be distributed over a much larger volume of zirconium so hydride precipitate formation will be delayed.

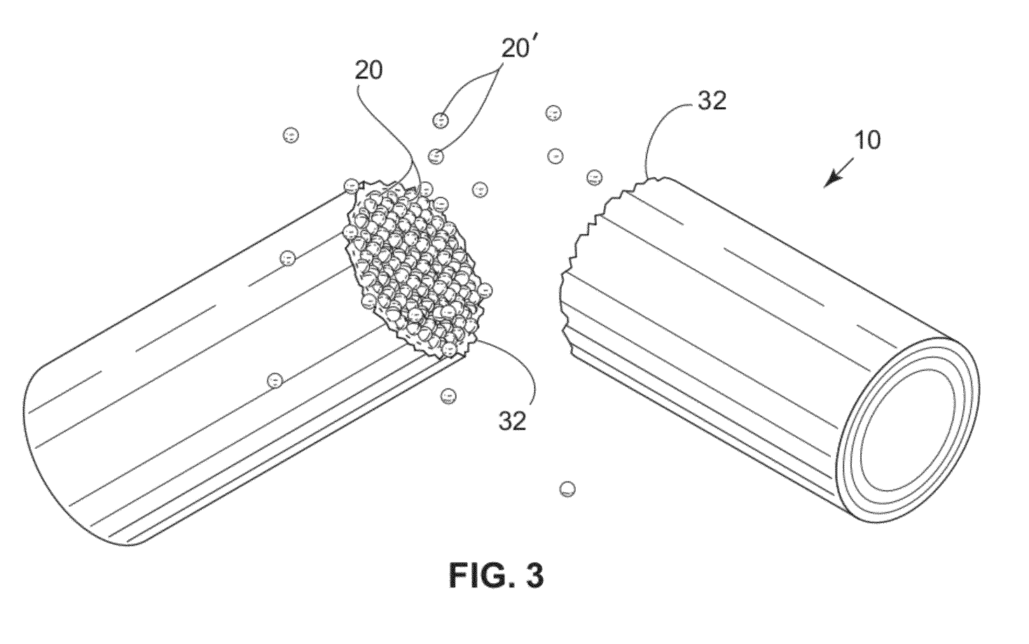

FIG. 3 illustrates the behavior the fuel of the present invention in severe case of fuel failure where the fuel rod 10 is fractured. The surface of the metal matrix exposed to the coolant exhibits similar protective properties as fuel rod's original surface. Except for those fuel particles 20′ at the fracture line 32, fuel particles 20 will not be released into the coolant. This is in contrast to conventional fuel rods that release large amounts of the contents into the coolant upon fracture.

The temperatures of fuel fabrication processes are much higher than the heat treatment temperatures that are utilized for precipitate formation in zirconium alloy. Fuel fabrication generally takes place while zirconium is in the beta-phase (temperatures higher than ˜850° C.) while heat treatments are done at lower temperatures after quenching from the beta-phase to alpha-phase of zirconium. Such precipitates are essential for irradiation and corrosion resistance of the zirconium metal matrix and can be easily incorporated into the metal using the well-established heat treatment techniques after the fuel rod consolidation. The following two publications are suggested:
K. N. Choo, Y. H. Kang, S. I. Pyun, V. F. Urbanic, “Effect of composition and heat treatment on the microstructure and corrosion behavior of Zr—Nb alloys,” J. Nucl. Mater., 209, (1994), pp. 226
J. M. Kim, Y. H. Jeong, “Correlation of heat treatment and corrosion behavior of Zr—Nb—Sn—Fe—Cu alloys,” J. Nucl. Mater., 104, (2000), pp. 145

In the present invention, it is important to minimize or even eliminate porosity while minimizing formation of detrimental reactants on the exterior surfaces of the particles. Therefore, hot pressing, hot-isostatic pressing, and other consolidation processes carried out at temperatures in the range of 800-1400° C. are contemplated.

Zirconium metal is not susceptible to void swelling by fast neutron irradiation. However, zirconium alloy cladding grows due to the anisotropy of the microstructure as a result of the tube extrusion process. In examples of the present invention, the zirconium microstructure is close to isotropic after the fabrication and heat treatment steps; hence fuel rod growth is not a limiting factor during fuel operation. Moreover, since the microencapsulated fuel particles confine the fission gas, swelling due to void formation observed in metallic U—Zr fuels is eliminated.

The internal design of BISO, TRISO, and QUADRISO particles is well established and characterized; hence the major focus of the invention is the dispersion of the fuel particles into the Zirconium metal matrix. The ultimate goal is to achieve adequate heavy-metal density in the fuel for appropriate cycle lengths while having well-distributed, microencapsulated particles that offer high performance with respect to fission gas and solid fission product retention. The skilled artisan will recognize that appropriate processing techniques and conditions for incorporation of the desired fuel particles with outermost coating layers of SiC, ZrC, or pyrolitic carbon into the zirconium alloy matrix can be designed such that microstructure and interface between the particle and the matrix can be effectively engineered.

The interface between the metal matrix and the TRISO particle functions as a diffusion barrier to suppress migration of metal atoms into the particle and vice versa. The state of stress at the interface influences particle performance and crack propagation across the fuel. Therefore the skilled artisan will recognize the necessity of an appropriate mix of compositions and processing conditions that are necessary to yield the appropriate compressive state of stress in this layer to hold the particle and its layer intact during fuel operation and subsequent pressurization of the particles. Meanwhile the cohesive strength at the interface should be somewhat weak to deflect possible cracks in the matrix away from penetrating into the particle.

### Example I

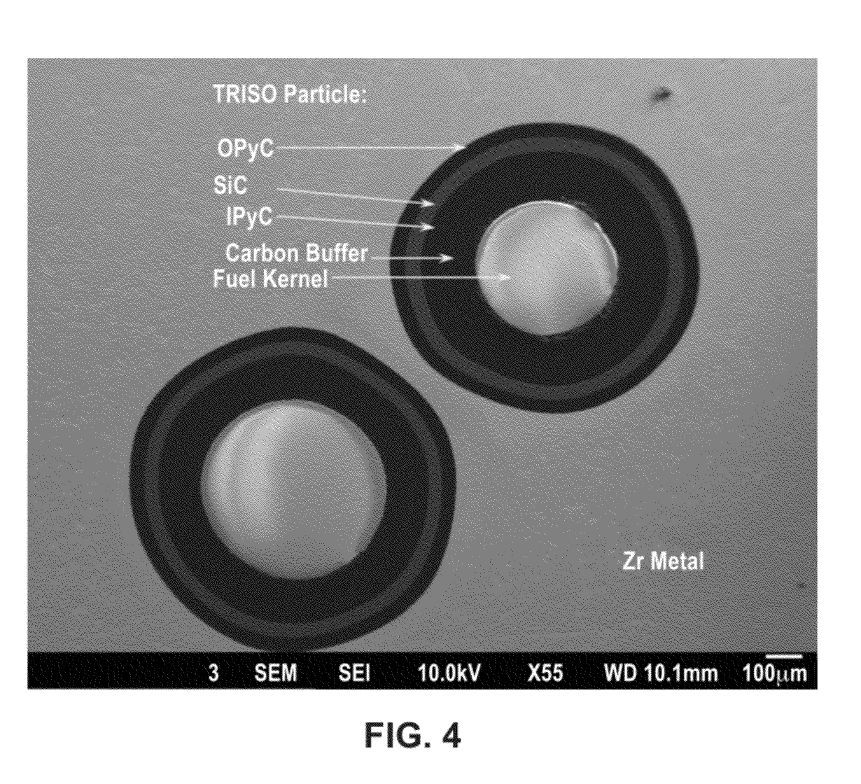

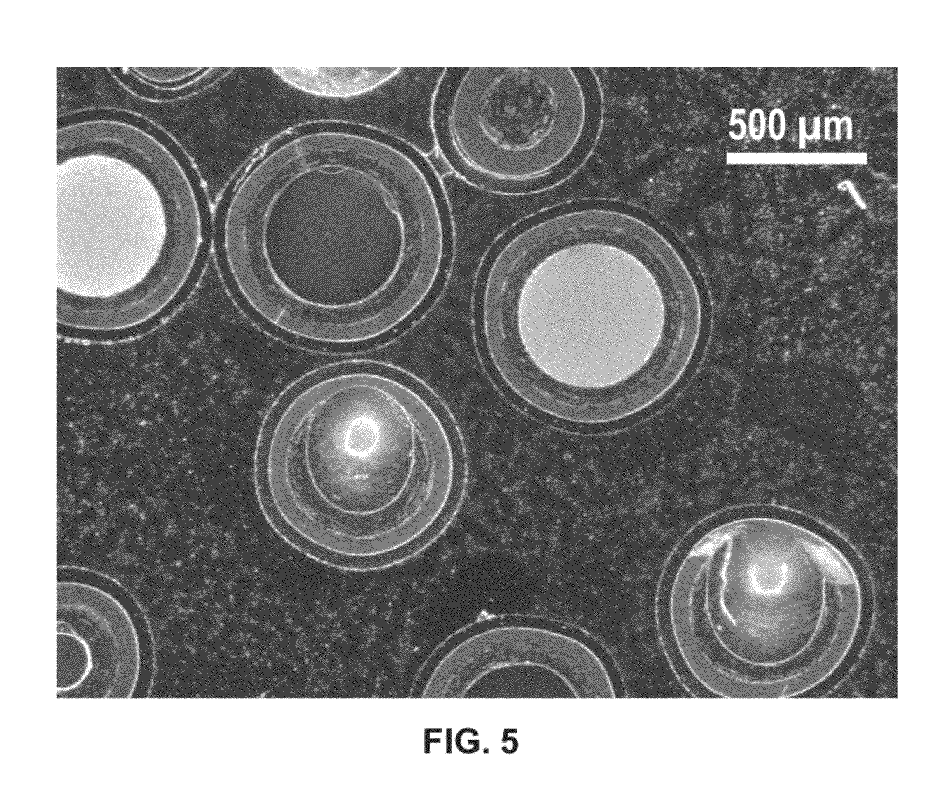

In accordance with examples of the present I invention, a mixture of zirconium metal powder and TRISO particles were consolidated by hot-pressing under vacuum at 1000° C. under 15 MPa of pressure for one hour. A photomicrograph of the resulting product is shown in FIG. 4.

### Example II

A fuel rod was fabricated in accordance with examples of the present invention. A zirconium metal tube was filled with a mixture of zirconium metal powder and TRISO particles having no OPyC layer. The filled tube was consolidated by hot isostatic pressing at 1050° C. under 25 MPa of isostatic inert gas pressure for 1 hour. The resulting composite fuel rod was fully dense and adherently integral, as shown in FIG. 4. It should be noted that during cutting and polishing for microscopy sample preparation the kernel has been dislodged from some of the particles and in some cases has damaged the buffer and inner pyrocarbon layers. Such irregularities are evident in FIG. 4; however, persistent adherence of the silicon carbide outer layers of the TRISO particles to the zirconium matrix during sample preparation is also evident, a strong indication that the particles will remain with the matrix and not be released in case of fuel rod fracture.

The skilled artisan will recognize that various fabrication methods may be employed in carrying out the present invention. Suitable methods include hot isostatic pressing and extrusion. In case of other fuel geometries (e.g. plates, pebbles or annular rods) other techniques such as hot-pressing, sintering, hot-rolling, plasma arc sintering, and pneumatic isostatic forging can also be utilized. The skilled artisan will further recognize that processing conditions such as, for example, pressure and temperature ranges, for such methods can be optimized in order to achieve the desired characteristics described hereinabove.

The skilled artisan will further recognize that mechanical, thermal, and neutronic modeling of the fuel is expected to provide feedback with regards to the expected in-pile performance of the fuel in the design zirconium alloy matrix. Moreover, this step also identifies the parameters that have the most significant impact on fuel performance and provides the means for optimization thereof during definition of design parameters.

The skilled artisan will further recognize that, after test fuel rods are fabricated under different testing conditions, detailed characterization of the fuel microstructure and properties can be conducted at every stage in order to then to iterate with the fabrication step and improve the as fabricated properties. A useful description of the general set of activities needed for fuel development and qualification process are provided by Crawford et al. The following publication is suggested:
D. C. Crawford, D. L. Porter, S. L. Hayes, M. K. Meyer, D. A. Petti, and K. Pasamehmetoglu. “An approach to Fuel Development and Qualification,” J. Nucl. Mater., 371, (2007), pp. 232

After the fuel development and qualification activities are completed, nuclear fuel can be fabricated in accordance with the present invention and incorporated into a nuclear reactor to produce energy.

While there has been shown and described what are at present considered to be examples of the invention, it will be obvious to those skilled in the art that various changes and modifications can be prepared therein without departing from the scope of the inventions defined by the appended claims.

What is claimed is:

1. A metal matrix, microencapsulated nuclear fuel component comprising:
a. an integral metal matrix having an outer buffer region and an inner fuel containing region;
b. a multiplicity of nuclear fuel capsules embedded in said fuel containing region of said matrix for encapsulating a nuclear fuel particle and products resulting from nuclear and chemical reactions; and
c. a nuclear fuel particle encapsulated in each of said nuclear capsules.

2. A metal matrix, microencapsulated nuclear fuel component in accordance with claim 1 wherein said integral metal matrix comprises zirconium.

3. A metal matrix, microencapsulated nuclear fuel component in accordance with claim 2 wherein said zirconium comprises a zirconium alloy.

4. A metal matrix, microencapsulated nuclear fuel component in accordance with claim 1 wherein said nuclear fuel capsules adhere to said integral metal matrix.

5. A metal matrix, microencapsulated nuclear fuel component in accordance with claim 1 wherein said nuclear fuel capsules comprise at least one microencapsulated form selected from the group consisting of quadristructural-isotropic capsules, tristructural-isotropic capsules, and bistructural-isotropic capsules.

6. A metal matrix, microencapsulated nuclear fuel component in accordance with claim 1 wherein said tristructural-isotropic capsules have no outer pyrolytic carbon layer.

7. A method of making a metal matrix, microencapsulated nuclear fuel component comprising the steps of:
a. providing a mixture comprising:
i. a multiplicity of nuclear fuel capsules for encapsulating a nuclear fuel particle and products resulting from nuclear and chemical reactions,
ii. a nuclear fuel particle encapsulated in each of said nuclear capsules and
iii. a metal powder;
b. at least partially filling a metal tube with said mixture;
c. consolidating said at least partially filled metal tube to form a metal matrix, microencapsulated nuclear fuel component having an integral metal matrix having an outer buffer region and an inner fuel containing region, said nuclear fuel capsules embedded in said fuel containing region of said matrix.

8. A method of making a metal matrix, microencapsulated nuclear fuel component in accordance with claim 6 wherein said integral metal matrix comprises zirconium.

9. A method of making a metal matrix, microencapsulated nuclear fuel component in accordance with claim 7 wherein said integral metal matrix comprises a zirconium alloy.

10. A method of making a metal matrix, microencapsulated nuclear fuel component in accordance with claim 6 wherein said nuclear fuel capsules adhere to said integral metal matrix.

11. A method of making a metal matrix, microencapsulated nuclear fuel component in accordance with claim 6 wherein said nuclear fuel capsules comprise at least one microencapsulated form selected from the group consisting of quadristructural-isotropic capsules, tristructural-isotropic capsules, and bistructural-isotropic capsules.

12. A method of making a metal matrix, microencapsulated nuclear fuel component in accordance with claim 6 wherein said consolidating step comprises at least one process selected from the group consisting of pressing, hot isotactic pressing, and extrusion.
